(19) United States
(12) Patent Application Publication
(10) Pub. No.: US 2025/0252175 A1
(43) Pub. Date: Aug. 7, 2025

(54) BATTERY AUTHENTICATION SYSTEM

(71) Applicant: DENSO CORPORATION, Kariya-city (JP)

(72) Inventors: Kazuya TAKIZAWA, Kariya-city (JP); Hiroki FUJII, Kariya-city (JP); Shuhei YOSHIDA, Kariya-city (JP)

(21) Appl. No.: 19/184,196

(22) Filed: Apr. 21, 2025

Related U.S. Application Data
(63) Continuation of application No. PCT/JP2023/036968, filed on Oct. 12, 2023.

(30) Foreign Application Priority Data
Oct. 25, 2022 (JP) 2022-170611

(51) Int. Cl. G06F 21/44

(52) U.S. Cl. CPC G06F 21/44

(57) ABSTRACT

A battery authentication system includes a data obtaining unit, a data standardization unit, a code generation unit, a degradation state calculating unit, a degradation state integration unit, and a degradation state providing unit. The data obtaining unit obtains and records time-series battery data including signal values and physical values of a secondary battery. The data standardization unit standardizes the signal values and the physical values. The code generation unit generates a first identification code based on the standardized signal values. The degradation state calculating unit calculates a degradation state of the secondary battery based on the standardized physical values. The degradation state integration unit integrates the first identification code with the degradation calculation result to generate a second identification code. The degradation state providing unit verifies the first identification code based on the second identification code, and outputs the degradation calculation result based on the verification.

### CROSS REFERENCE TO RELATED APPLICATIONS

The present application is a continuation application of International Patent Application No. PCT/JP2023/036968 filed on Oct. 12, 2023, which designated the U.S. and claims the benefit of priority from Japanese Patent Application No. 2022-170611 filed on Oct. 25, 2022. The entire disclosures of all the above applications are incorporated herein by reference.

### TECHNICAL FIELD

The present disclosure relates to a battery authentication system that performs individual authentication of a battery.

### BACKGROUND

There is a charging system that authenticates an electric vehicle equipped with a secondary battery.

### SUMMARY

A battery authentication system according to one aspect of the present disclosure includes a data obtaining unit, a data standardization unit, a code generation unit, a degradation state calculation unit, a degradation state integration unit, and a degradation state providing unit.

The data obtaining unit is configured to obtain time-series battery data including signal values indicative of a state of a secondary battery and physical values indicative of physical quantities of the secondary battery, and records the time-series battery data based on a predetermined rule. The data standardization unit is configured to standardize the signal values and the physical values that are recorded based on different rules by re-recording the signal values and the physical values using a common rule. The code generation unit is configured to generate a first identification code to identify the secondary battery based on the standardized signal values. The degradation state calculation unit is configured to calculate the degradation state of the secondary battery based on the standardized physical values to obtain a degradation calculation result. The degradation state integration unit is configured to integrate the first identification code with the degradation calculation result to generate a second identification code which includes the degradation calculation result. The degradation state providing unit is configured to verify the first identification code based on the second identification code in response to a request for the degradation calculation result using the first identification code, and output the degradation identification result contained in the second identification code based on verification of the first identification code.

According to another aspect, a battery authentication system including a data obtaining unit, a data standardization unit, a code generation unit, a degradation state calculating unit, a degradation state integration unit, and a degradation state providing unit.

The data obtaining unit obtains multiple pieces of impedance data of a secondary battery measured at different frequencies, and records the multiple pieces of impedance data based on a predetermined rule. The data standardization unit standardizes the multiple pieces of impedance data that are recorded based on different rules by re-recording the multiple pieces of impedance data using a common rule. The code generation unit generates a first identification code to identify the secondary battery based on the standardized impedance data. The degradation state calculating unit calculates a degradation state of the secondary battery to obtain a degradation calculation result. The degradation state integration unit integrates the first identification code with the degradation calculation result of the secondary battery to generate a second identification code containing the degradation calculation result. The degradation state providing unit verifies the first identification code based on the second identification code in response to a request for the degradation calculation result using the first identification code, and outputs the degradation calculation result included in the second identification code based on verification of the first identification code.

### BRIEF DESCRIPTION OF THE DRAWINGS

FIG. 1 is a schematic diagram illustrating a battery authentication system according to a first embodiment.

FIG. 2 is a diagram showing a specific example of battery data.

FIG. 3 is a block diagram illustrating functions of the battery authentication system according to the first embodiment.

FIG. 4 is a flowchart showing a process flow of the battery authentication system.

FIG. 5 is a diagram showing a specific example of separation of the battery data.

FIG. 6 shows a specific example of standardization of physical values and signal values.

FIG. 7 is a diagram showing a specific example of generation of a first identification code.

FIG. 8 shows an example of recombination of the physical values and the signal values.

FIG. 9 is a diagram showing a specific example of a degradation calculation of a secondary battery.

FIG. 10 is a diagram showing a specific example of data combination of the calculation result and the first identification code.

FIG. 11 is a schematic diagram illustrating a battery authentication system according to a second embodiment.

FIG. 12 is a block diagram illustrating functions of the battery authentication system according to the second embodiment.

FIG. 13 is a diagram for explaining complex impedance Z of a third embodiment.

FIG. 14 is a diagram showing a specific example of impedance obtained at different frequencies in the third embodiment.

FIG. 15 is a diagram showing a specific example of standardization of the impedance data according to the third embodiment.

FIG. 16 is a diagram showing a specific example of generation of a first identification code according to the third embodiment.

FIG. 17 is a configuration diagram showing a modified example of the battery authentication system.

### DETAILED DESCRIPTION OF THE PREFERRED EMBODIMENTS

To begin with, examples of relevant techniques will be described.

There is a charging system that authenticates an electric vehicle equipped with a secondary battery. The charging system performs authentication by comparing the charging state of the secondary battery obtained through wired communication with the charging state of the secondary battery obtained through wireless communication when charging the secondary battery of the electric vehicle at a charging station.

However, the charging system uses the current charging state of the secondary battery to perform individual authentication. Thus, it is impossible to accurately perform individual authentication for multiple batteries having the same charging state. Additionally, the charging system can recognize the current charging state of the secondary battery, but it cannot recognize the degradation state of the secondary battery.

In view of the above, it is an objective of the present disclosure to improve the reliability of individual authentication of a secondary battery in a battery authentication system, and make it possible to recognize the degradation state of the secondary battery during individual authentication.

A battery authentication system according to one aspect of the present disclosure includes a data obtaining unit, a data standardization unit, a code generation unit, a degradation state calculation unit, a degradation state integration unit, and a degradation state providing unit.

The data obtaining unit is configured to obtain time-series battery data including signal values indicative of a state of a secondary battery and physical values indicative of physical quantities of the secondary battery, and records the time-series battery data based on a predetermined rule. The data standardization unit is configured to standardize the signal values and the physical values that are recorded based on different rules by re-recording the signal values and the physical values using a common rule. The code generation unit is configured to generate a first identification code to identify the secondary battery based on the standardized signal values. The degradation state calculation unit is configured to calculate the degradation state of the secondary battery based on the standardized physical values to obtain a degradation calculation result. The degradation state integration unit is configured to integrate the first identification code with the degradation calculation result to generate a second identification code which includes the degradation calculation result. The degradation state providing unit is configured to verify the first identification code based on the second identification code in response to a request for the degradation calculation result using the first identification code, and output the degradation identification result contained in the second identification code based on verification of the first identification code.

This improves the reliability of individual authentication of the secondary battery, and makes it possible to recognize the degradation state of the secondary battery during individual authentication.

The following describes multiple embodiments for implementing the present disclosure with reference to the drawings. In each embodiment, parts corresponding to matters described in preceding embodiments are assigned the same reference numerals, and redundant explanations may be omitted. If only a part of the configuration is described in each embodiment, other parts of the configuration can be applied by referring to other previously described embodiments. Not only the combinations of parts explicitly indicated as combinable in each embodiment, but also partial combinations of the embodiments themselves are possible, as long as there is no particular hindrance to the combination, even if not explicitly stated.

(First Embodiment) The first embodiment of the present disclosure is described below with reference to the drawings.

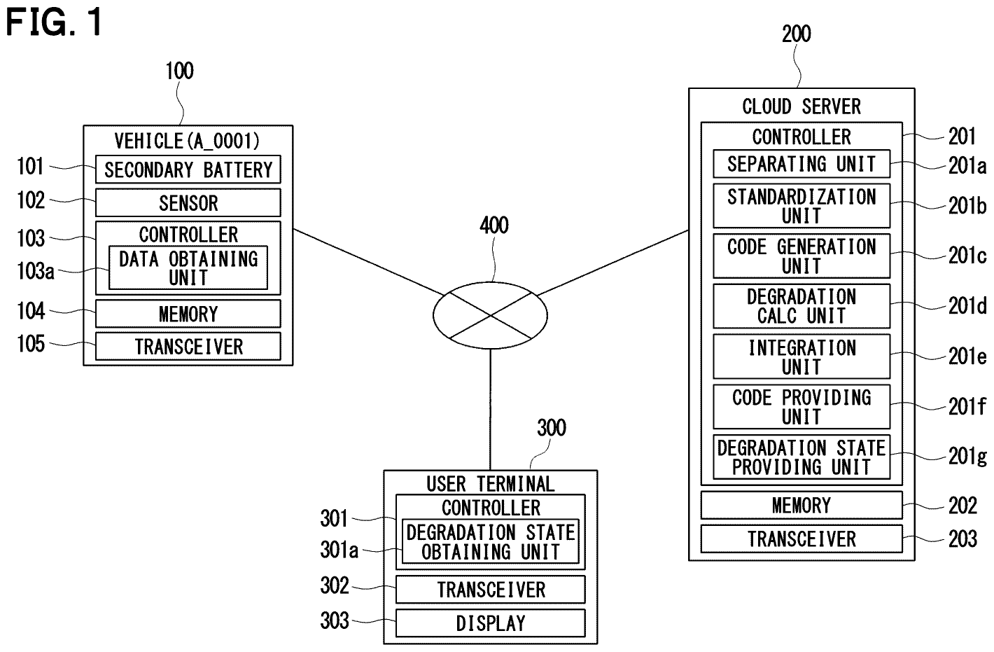

As shown in FIG. 1, a battery authentication system of the first embodiment includes a vehicle 100, a cloud server 200, and a user terminal 300. The vehicle 100, the cloud server 200, and the user terminal 300 are connected via a communication network 400. The communication network 400 may be a wide area network such as the Internet.

The vehicle 100 is an electrically powered mobile object that moves using a secondary battery 101 as a power source. The vehicle 100 includes the secondary battery 101, a sensor 102, a vehicle controller 103, a vehicle memory 104, and a vehicle transceiver 105.

The secondary battery 101 constitutes a battery module in which multiple battery cells that are chargeable and dischargeable are connected in series. Each battery cell is, for example, a lithium ion secondary battery. The battery module may include a configuration in which each battery cell is connected in parallel.

The vehicle 100 is an electric vehicle that drives a driving motor (not shown) using the secondary battery 101 as a power source. The vehicle 100 is an electric device that operates using the secondary battery 101 as a power source.

The vehicle 100 include a variety of vehicles. The variety of vehicles include vehicles of different models, and further include multiple vehicles of the same model that have different serial numbers.

The vehicle 100 of this embodiment may be a vehicle identified by, for example, vehicle number A_0001. The vehicle number is a unique identification (ID) number given to each vehicle 100, and vehicle number A_0001 means vehicle number 0001 of vehicle type A. When the vehicle 100 and the secondary battery 101 have a one-to-one relationship, the vehicle number A_0001 is unique information of the secondary battery 101. Thus, the vehicle number A_0001 may be the ID number of the secondary battery 101.

The vehicle 100 may be of a battery replaceable type in which the secondary battery 101 is replaceable. If the vehicle 100 is a battery-replaceable type, the secondary battery 101 can be distributed independently and separately from the vehicle 100.

The sensor 102 is provided to measure the physical values of the secondary battery 101. The physical values of the secondary battery 101 include at least the current value and the temperature of the secondary battery 101. The sensor 102 includes at least a current sensor that measures the current value of the secondary battery 101 and a temperature sensor that measures the temperature of the secondary battery 101. The physical values of the secondary battery 101 may include a voltage value of the secondary battery 101, and the sensor 102 may include a voltage sensor that measures the voltage value of the secondary battery 101. The sensor 102 detects the current value and the temperature periodically. The sensor 102 outputs detection signals to a data obtaining unit 103a, which will be described later.

The vehicle controller 103 includes a microcomputer including CPU, ROM and RAM, and peripheral circuits thereof. The vehicle controller 103 performs various calculations and processes based on control programs stored in the ROM, and controls operations of various control target devices. The vehicle controller 103 serves as the data obtaining unit 103a that obtains battery data of the secondary battery 101.

The vehicle memory 104 is a writable and readable non-volatile storage medium. The vehicle memory 104 stores battery data including physical values.

The vehicle transceiver 105 includes a transmitter that transmits data to the outside and a receiver that receives data from the outside. The vehicle transceiver 105 can communicate with the cloud server 200 via the communication network 400.

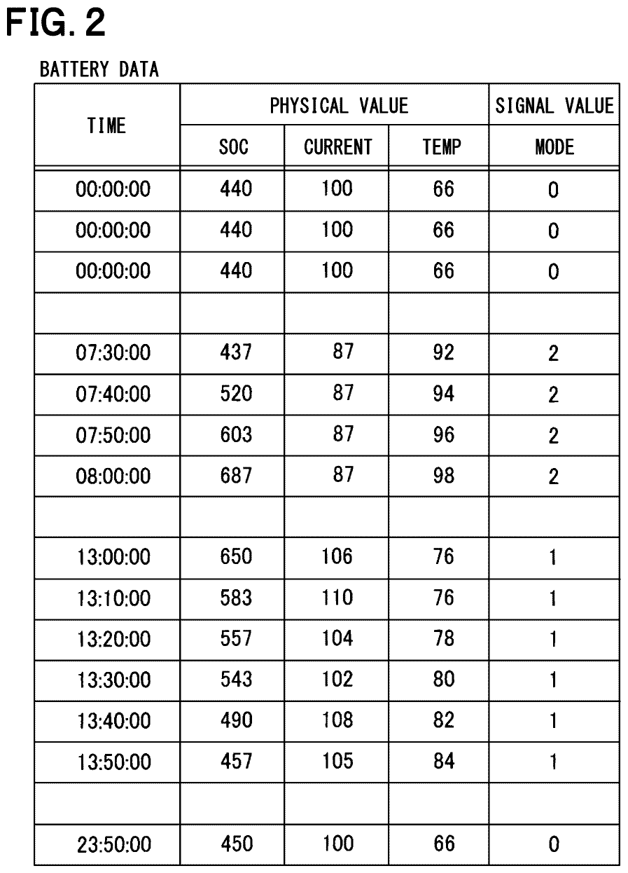

FIG. 2 shows a specific example of the battery data. As shown in FIG. 2, the battery data includes physical values and signal values. FIG. 2 shows battery data used in the vehicle model A.

The physical values are values indicating physical quantities of the secondary battery 101. The physical value is a value whose absolute value (that is, the magnitude of the numerical value) has meaning. The physical values include at least the state of charge (i.e., SOC), the current value, and the temperature of the secondary battery 101. The current value is a value measured by the current sensor, and the temperature is a value measured by the temperature sensor.

The SOC is a charging rate of the secondary battery 101, and is a ratio of the remaining capacity to the full charge capacity of the secondary battery 101 expressed in percentage. The SOC of the secondary battery 101 may be obtained by any method. In this embodiment, the SOC is obtained by the current integration method. Specifically, the vehicle controller 103 integrates the current values of the secondary battery 101 obtained by the current sensor, and calculates the SOC of the secondary battery 101 based on the obtained integrated value of the current values.

The physical values are recorded in different rules depending on vehicle models (or types of the secondary battery 101). In the example shown in FIG. 2, the definition of Least Significant Byte (i.e., LSB) of the physical value is different between vehicle models. The LSB is the least significant byte of the string representing the physical value. In the example of the vehicle model A shown in FIG. 2, it is defined that the LSB of the SOC is 0.1%, the LSB of the current value is 1 A and an offset of the current value is −100, and the LSB of the temperature is 0.5° C.

If the LSB of the SOC is 0.1%, the SOC expressed as “440” means “44.0%.” If the LSB of the current value is 1 A and the offset is −100 A, the current value represented by “100” means “0 A”. If the LSB of the temperature is 0.5° C., the temperature represented by “66” means “33° C.”.

The signal values are values that indicate the state of the secondary battery 101, and the absolute value of the signal values has no meaning. The signal value is a value defined for identifying the state of the secondary battery 101. The state of the secondary battery 101 includes the charge and discharge state of the secondary battery 101. In other words, the signal value is data that indicates the usage history (e.g., the charge state and discharge state) of the battery. In this embodiment, since the secondary battery 101 is used as a power source for driving the vehicle 100, the state of the vehicle 100 related to the state of the secondary battery 101 is used as the signal values.

The states of the vehicle 100 defined as the signal values include at least a moving state, a stopped state, and a charging state. The moving state is a state in which the power switch of the vehicle 100 is on and the vehicle 100 is capable of running. The stopped state is a state in which the power switch of the vehicle 100 is turned off and the vehicle 100 cannot run. In the stopped state, charging and discharging of the secondary battery 101 is not performed. The charging state is a state in which the secondary battery 101 is being charged, and a charging port of the vehicle 100 is connected to a charger (not shown). The signal value may be any value that can identify whether the vehicle 100 is in the moving state, the stopped state, or the charging state.

Like the physical values, the signal values are described in different rules depending on vehicle models (or types of the secondary battery 101). In the example of the vehicle type A shown in FIG. 2, the stopped state is defined as signal value “0”, the moving state as signal value “1”, and the charging state as signal value “2”.

As shown in FIG. 2, the battery data is time-series data obtained at multiple times. That is, the battery data consists of multiple physical values and multiple signal values obtained at different times. The battery data may be regarded as usage history data of the secondary battery 101. The time-series battery data are different among the vehicles 100. Thus, the time-series data of the battery data is information specific to the vehicle 100 and the secondary battery 101.

The data obtaining unit 103a obtains battery data at predetermined intervals. FIG. 2 shows an example in which the data obtaining unit 103a obtains battery data every 10 minutes for 24 hours.

The period during which the data obtaining unit 103a obtains the battery data can be set arbitrarily. The period may be a period during which a change appears in the time-series data of the battery data. The period during which the data obtaining unit 103a obtains the battery data may be a period during which the usage state of the vehicle 100 (i.e., the usage state of the secondary battery 101) changes. The battery data obtaining period may be several hours or more, and may be 24 hours or more. The vehicle memory 104 accumulates and stores the time-series battery data obtained by the data obtaining unit 103a.

With reference to FIG. 1 again, the cloud server 200 includes a cloud controller 201, a cloud memory 202, and a cloud transceiver 203.

The cloud controller 201 consists of a microcomputer including CPU, ROM and RAM, and peripheral circuits thereof. The cloud controller 201 performs various calculations and processes based on control programs stored in the ROM, and controls operations of various control target devices.

The cloud controller 201 serves as a data separating unit 201a, a data standardization unit 201b, a code generation unit 201c, a degradation state calculating unit 201d, a degradation state integration unit 201e, a code providing unit 201f, and a degradation state providing unit 201g. The data separating unit 201a separates physical values and signal values from the battery data. The data standardization unit 201b standardizes the physical values and the signal values. The code generation unit 201c generates a first identification code. The degradation state calculating unit 201d calculates the degradation state of the secondary battery 101. The degradation state integration unit 201e integrates the first identification code and the degradation calculation result of the secondary battery 101 to generate a second identification code. The code providing unit 201f provides the first identification code to the user terminal 300. The degradation state providing unit 201g provides the degradation calculation result of the secondary battery 101 to the user terminal 300. Details will be described later.

In this embodiment, the state of health (i.e., SOH) is used as the degradation state of the secondary battery 101. The SOH is the ratio of the current fully charged capacity of the secondary battery 101 to the initial fully charged capacity of the secondary battery 101, which is expressed as percentage.

The cloud memory 202 is a writable and readable non-volatile storage medium. The cloud memory 202 stores the second identification code in which the first identification code of the secondary battery 101 and the calculation result of the degradation state of the secondary battery 101 are integrated. The identification code is identification information for identifying the vehicle 100 or the secondary battery 101.

The cloud transceiver 203 includes a transmitter that transmits data to the outside and a receiver that receives data from the outside. The cloud transceiver 203 can communicate with the vehicle 100 and the user terminal 300 via the communication network 400.

The user terminal 300 is a communication device used by a user who performs individual authentication of the secondary battery 101. The user who uses the user terminal 300 is a person who is interested in the degradation state of the secondary battery 101. The user may be a used car dealer, a recovery company, or an owner of the vehicle 100. The user terminal 300 includes a terminal controller 301, a terminal transceiver 302, and a display 303. The user terminal 300 may be a smartphone or a tablet terminal.

The terminal controller 301 consists of a microcomputer including CPU, ROM and RAM, and peripheral circuits thereof. The terminal controller 301 performs various calculations and processes based on control programs stored in the ROM, and controls operations of various control target devices. The terminal controller 301 serves as a degradation state obtaining unit 301a that obtains the degradation state of the secondary battery 101.

The terminal transceiver 302 includes a transmitter that transmits data to the outside and a receiver that receives data from the outside. The terminal transceiver 302 can communicate with the user terminal 300 via the communication network 400.

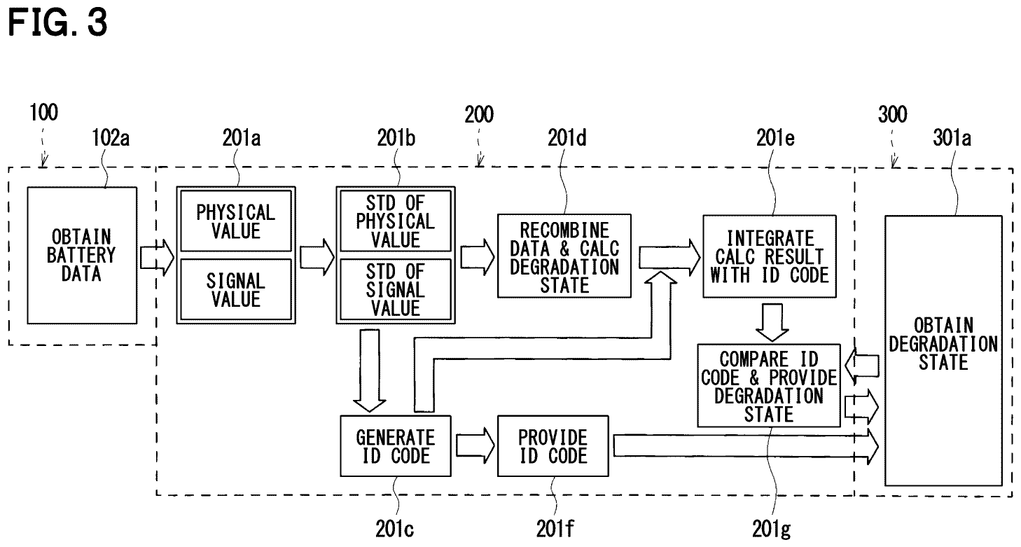

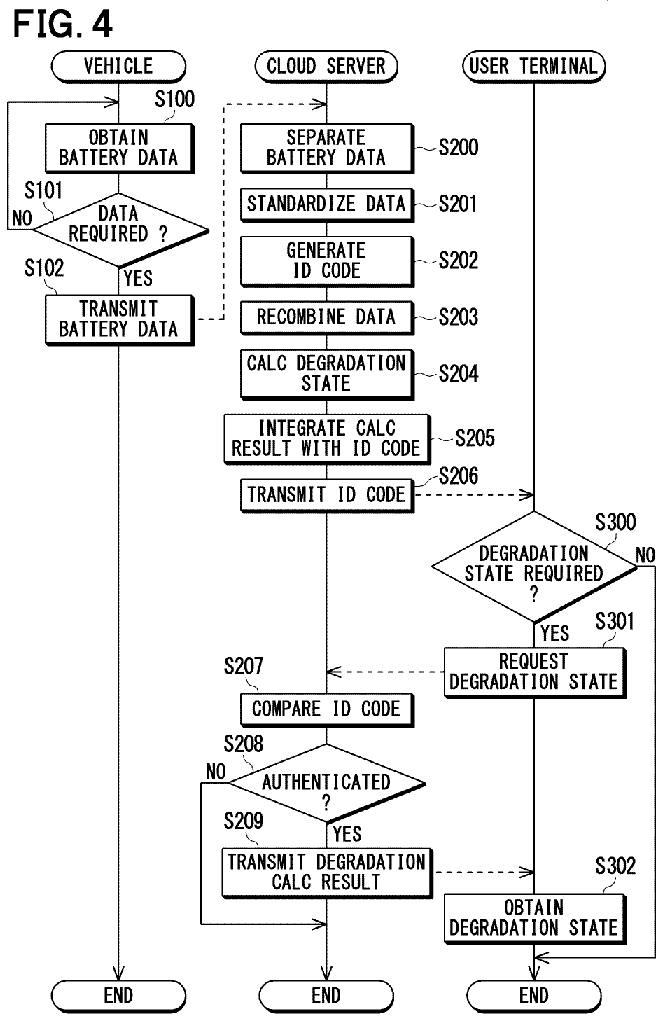

Next, the flow of each process in the vehicle 100, the cloud server 200, and the user terminal 300 in the authentication system of this embodiment will be described. FIG. 3 is a block diagram showing the functions of the vehicle 100, the cloud server 200, and the user terminal 300. FIG. 4 is a flowchart showing the operation of the battery authentication system of the present embodiment. Each process shown in the flowchart in FIG. 4 is basically executed under the control of the vehicle controller 103, the cloud controller 201, and the terminal controller 301.

First, the vehicle 100 obtains battery data of the secondary battery 101 in S100. Specifically, the data obtaining unit 103a obtains the battery data using the sensor 102, and the obtained battery data is stored in the vehicle memory 104.

Next, the vehicle 100 determines whether it is time to transmit the battery data from the vehicle 100 to the cloud server 200 in S101. If it is not determined that it is time to transmit the battery data, the battery data obtaining process in S100 is repeated until the transmission timing arrives. On the other hand, if it is determined that it is time to transmit the battery data, the battery data is transmitted from the vehicle 100 to the cloud server 200 in S102. The battery data may be time-series data for 24 hours. The battery data is transmitted to the cloud server 200 with being linked to a vehicle number, for example, A_0001.

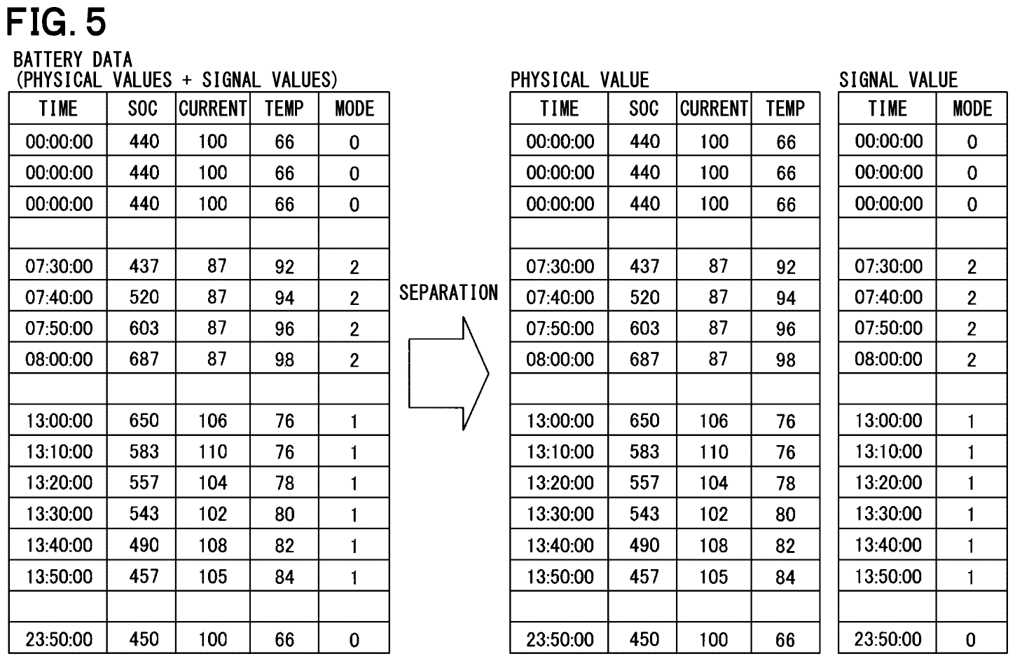

Next, the cloud server 200 that has received the battery data from the vehicle 100 separates the battery data in S200. The data separating unit 201a separates the battery data. As shown in FIG. 5, the data separating unit 201a separates the battery data into time series data of physical values and time series data of signal values.

Next, the cloud server 200 performs data standardization in S201. The data standardization unit 201b performs data standardization. As described above, the battery data is recorded based on rules defined for each vehicle model (or each battery type). Standardization means re-recording, according to unified common rules, the battery data that is recorded in different rules.

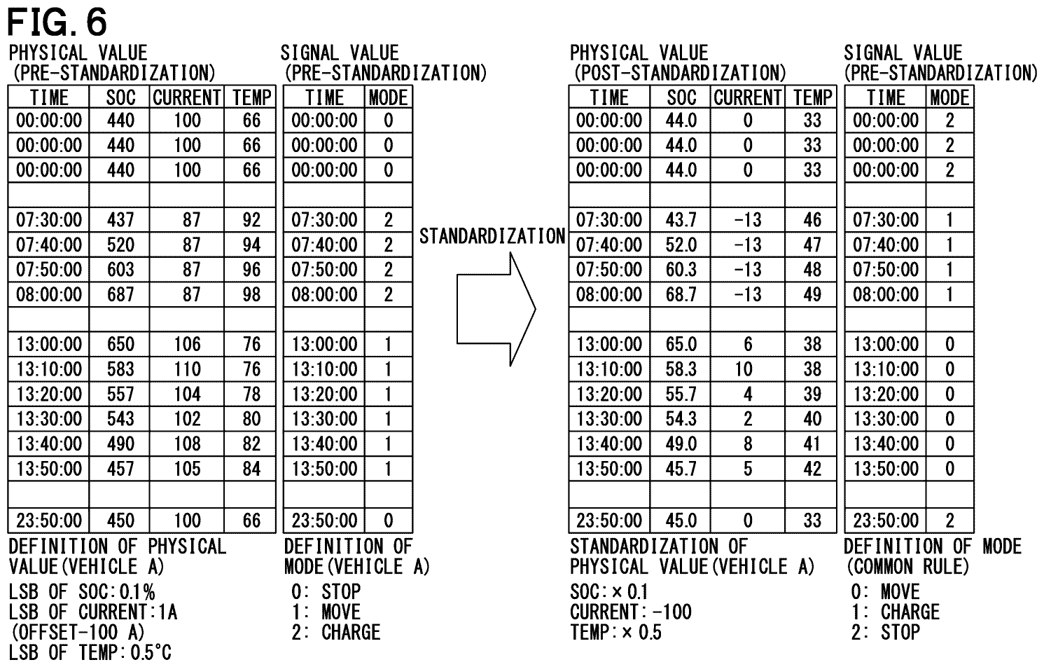

FIG. 6 shows the physical and signal values before and after standardization. As described above, the physical values of the vehicle type A are defined such that the LSB of SOC is 0.1%, the LSB of the current value is 1 A and an offset of the current value is −100 A, and the LSB of the temperature is 0.5° C. In the common rules to standardize the physical values, numerical values that are expressed in the usual decimal system are used. Thus, when standardizing the physical values of the vehicle type A, the SOC value is multiplied by 0.1, 100 is subtracted from the current value, and the temperature value is multiplied by 0.5. For example, pre-standardization values of SOC at 440(%), current value at 100 (A), and temperature at 66 (° C.) are converted to SOC at 44.0(%), current value at 0 (A), and temperature at 33 (° C.) by standardization.

As described above, the signal values of the vehicle type A is defined as “0” for the stopped state, “1” for the moving state, and “2” for the charging state. The common rules used for standardization define the driving state as “0,” the charging state as “1,” and the stopped state as “2.” Thus, when standardizing the signal values of the vehicle model A, “0” is converted to “2”, “1” is converted to “0”, and “2” is converted to “1”.

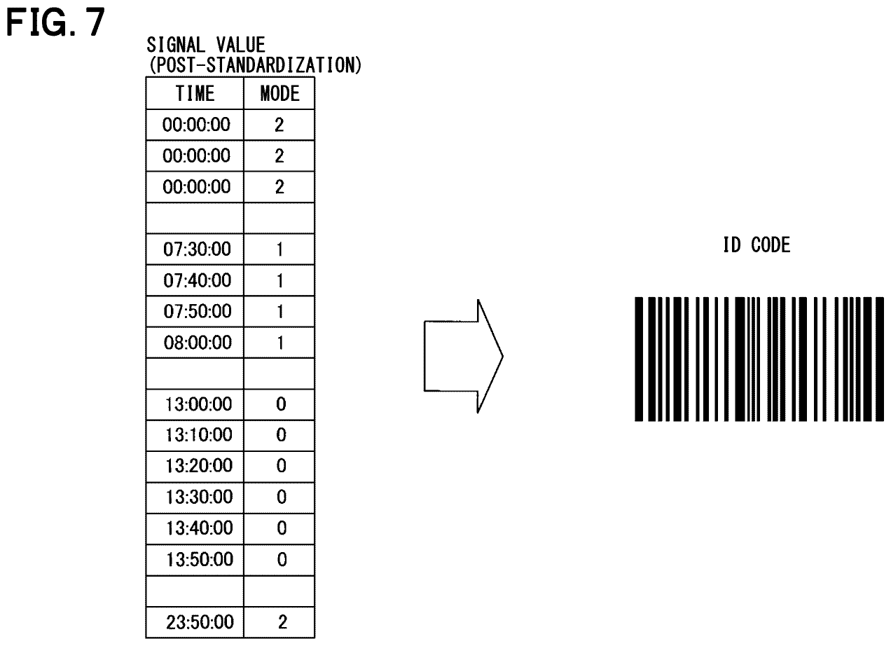

Next, the cloud server 200 generates a first identification code in S202. The identification code is generated by the code generation unit 201c. As shown in FIG. 7, the code generation unit 201c generates the first identification code using time-series data of the signal values. The time-series data of the signal values may be used as histogram data expressed as a frequency distribution. The first identification code is linked to the vehicle number A_0001.

The time-series data of the signal values is information specific to each vehicle 100 and different from one another. The time-series data of the signal values in this embodiment is unique information of the vehicle 100 identified by the vehicle number A_0001. Thus, the first identification code generated using the time-series data of the signal values also serves as information unique to the vehicle 100.

The first identification code is constructed by symbolizing the time-series data of the signal values. The first identification code displays information with an array of high and low optical reflectance areas and is mechanically readable. The first identification code may be a one-dimensional code or a two-dimensional code. In this embodiment, the first identification code is a one-dimensional code.

The code generation unit 201c generates the first identification code using the raw time-series data of the signal values, or process the time-series data of the signal values and generate the first identification code using the processed time-series data of the signal values. Alternatively, the first identification code may be an address indicating the location in the cloud memory 202 where the identification code with the calculation result is stored.

Next, the cloud server 200 recombines data in S203, and calculates the degradation state of the secondary battery 101 in S204. The degradation state calculating unit 201d performs the data recombination and degradation state calculation.

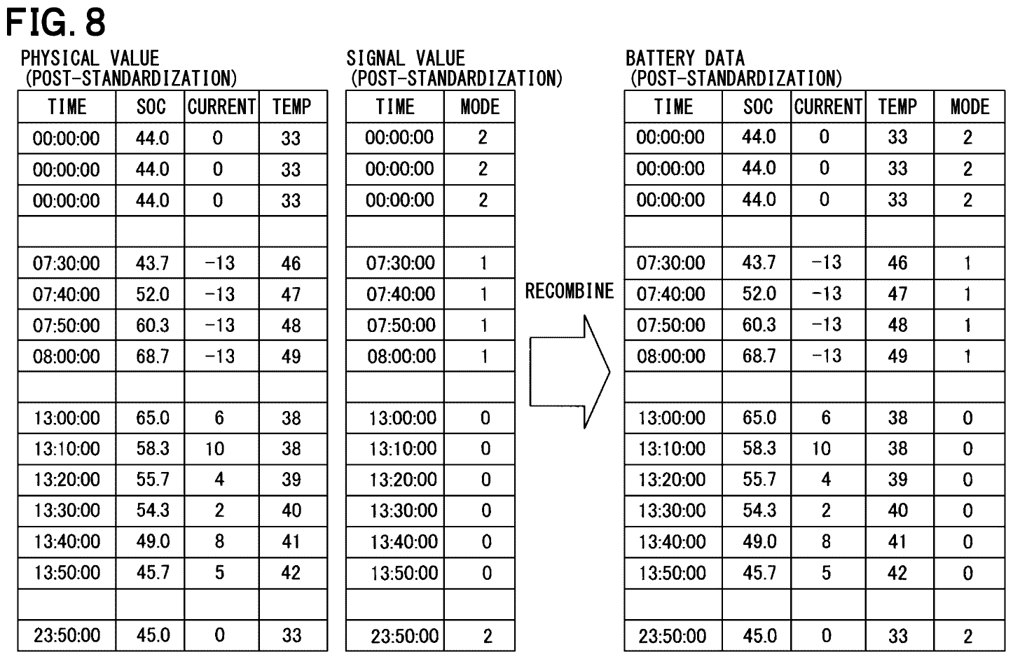

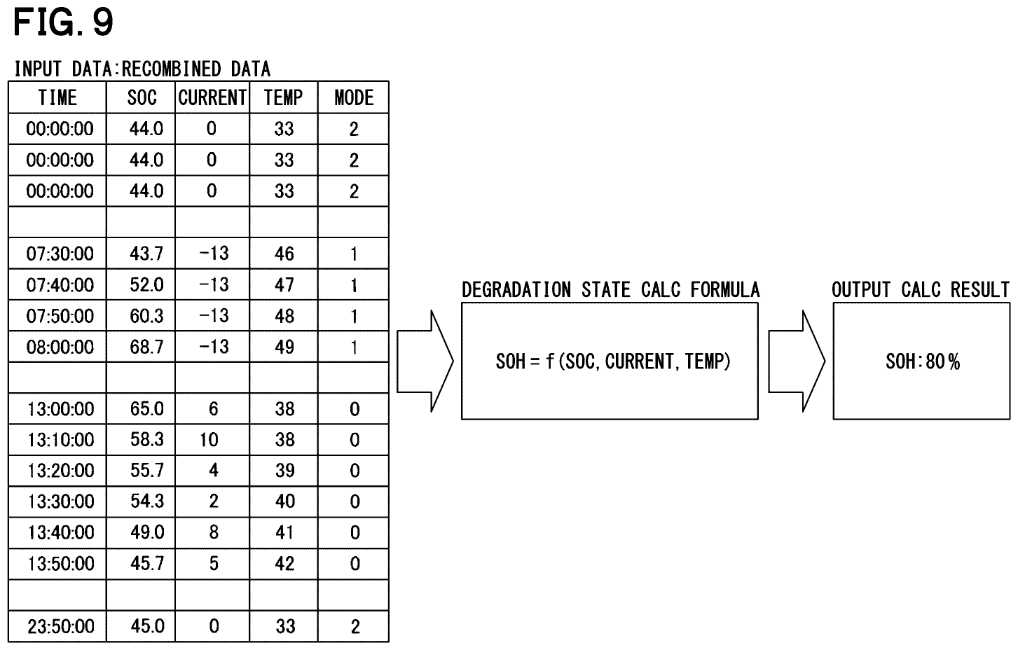

As shown in FIG. 8, the degradation state calculating unit 201d combines the standardized physical values and the standardized signal values. Subsequently, as shown in FIG. 9, the degradation state calculating unit 201d calculates the SOH, which indicates the degradation state of the secondary battery 101, by using the standardized physical values and a degradation state calculation formula. In this embodiment, the SOH is calculated as a function of the SOC, the current value, and the temperature. In calculating the SOH, the SOC, the current value, and the temperature may be used as histogram data in which the respective time series data are expressed as frequency distribution. In the example shown in FIG. 9, the degradation calculation result is 80% (SOH). In addition, the signal values may be used in addition to the physical values to calculate the SOH.

Next, in S205, the cloud server 200 integrates the first identification code of the secondary battery 101 with the degradation calculation result. The degradation state integration unit 201e integrates the first identification code with the degradation calculation result.

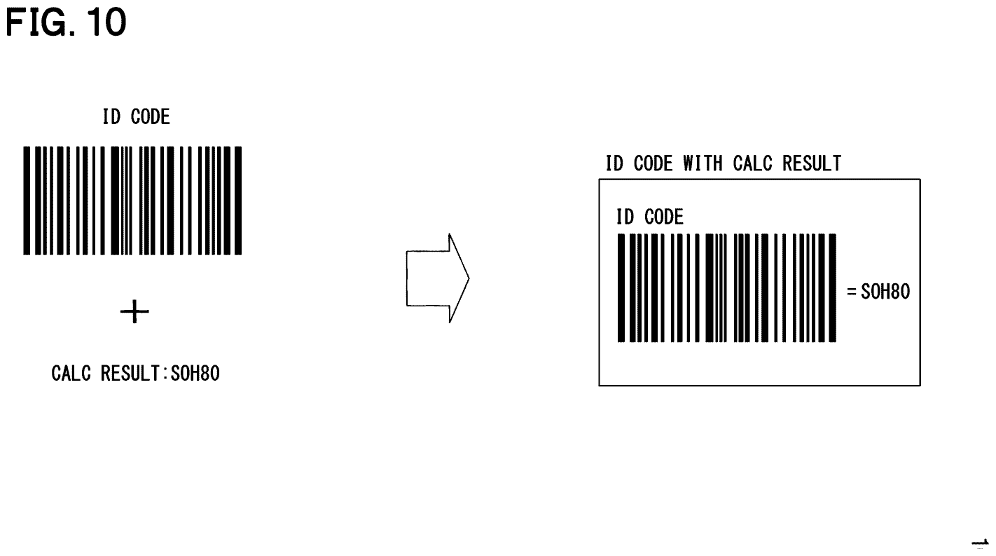

As shown in FIG. 10, the first identification code generated based on the time-series data of the signal values and the SOH indicating the degradation state of the secondary battery 101 are integrated to generate a second identification code which contains the calculation result. The second identification code containing the calculation result is stored in a predetermined area of the cloud memory 202. The cloud memory 202 accumulates the second identification codes with the calculation results of different vehicles 100, forming a database of the second identification codes.

Next, the cloud server 200 transmits and provides the first identification code to the user terminal 300 in S206. The code providing unit 201f provides the first identification code. Each first identification code is associated with a corresponding vehicle number (e.g., A_0001). The first identification code may be transmitted from the cloud server 200 to the user terminal 300 by e-mail.

Next, the user terminal 300 that has received the first identification code determines whether to obtain the degradation state of the secondary battery 101 in S300. The determination as to whether to obtain the degradation state of the secondary battery 101 may be made by determining whether a user (e.g., a used car dealer) has performed an operation on the user terminal 300 to obtain the degradation state of the secondary battery 101.

If it is determined in S300 that the degradation state of the secondary battery 101 is to be obtained, a request for the degradation state of the secondary battery 101 is made to the cloud server 200 in S301. The degradation state obtaining unit 301a makes a request for the degradation state of the secondary battery 101. In S301, the user terminal 300 transmits to the cloud server 200 the first identification code corresponding to the vehicle number (e.g., A_0001) for which the degradation state of the secondary battery 101 is requested.

Next, the cloud server 200, which has received the first identification code from the user terminal 300, compares in S207 the received first identification code with the second identification code that contains the calculation result stored in the cloud memory 202 to perform individual authentication.

Next, the cloud server 200 determines in S208 whether the first identification code transmitted from the user terminal 300 has been verified. If verification is successful in S208, the cloud server 200 in S209 transmits the degradation calculation result of the secondary battery 101 (for example, SOH at 80%) included in the second identification code to the user terminal 300. The degradation state providing unit 201g provides the degradation calculation result.

Next, the user terminal 300 obtains the degradation calculation result of the secondary battery 101 transmitted from the cloud server 200 in S302. The degradation state obtaining unit 301a obtains the degradation calculation result of the secondary battery 101. The user terminal 300 displays the degradation calculation result of the secondary battery 101 on the display 303, so that the user can recognize the degradation calculation result of the secondary battery 101.

In the present embodiment described above, the first identification code is generated based on the time-series data of the signal values included in the battery data. The first identification code is information unique to the vehicle 100 or the secondary battery 101. By using the first identification code to perform individual authentication, the individual authentication can be performed reliably, thereby improving the reliability of the individual authentication.

In this embodiment, if individual authentication using the first identification code is successfully performed, the cloud server 200 transmits to the user terminal 300 the degradation calculation result (e.g., SOH) of the secondary battery 101 linked to the first identification code. This allows the user to recognize the degradation state of the secondary battery 101.

In addition, in this embodiment, the cloud server 200 calculates the degradation state of the secondary battery 101. Thus, the data of the degradation state of the secondary battery 101 can be efficiently shared between the owner of the vehicle 100, used car dealers, recovery companies, and the like.

Furthermore, in this embodiment, the user can recognize the degradation state (e.g., SOH) of the secondary battery 101 and accurately estimate the remaining value of the secondary battery 101 based on the degradation state of the secondary battery 101. This allows, for example, a used car dealer to efficiently assess the price of the vehicle 100, and a recovery company to efficiently determine a recycling policy for the secondary use of the secondary battery 101.

Furthermore, recognizing the degradation state of the secondary battery 101 helps accurately calculate the charge capacity of the secondary battery 101, which leads to an accurate estimation of the possible travel distance of the vehicle 100.

Furthermore, the cloud server 200 collects the battery data of the secondary battery 101 and calculates the degradation state, so that the cloud server 200 can remotely manage the degradation state of the secondary battery 101 in use. Furthermore, the cloud server 200 can provide a notification of maintenance as necessary based on the degradation state of the secondary battery 101.

In addition, when secondary batteries 101 are distributed independently, such as in a battery-exchangeable vehicle 100, it is possible to combine multiple secondary batteries 101 with the same deterioration state since the cloud server 200 has the information of the degradation state of the secondary battery 101. This allows the secondary batteries 101 to be used efficiently.

Furthermore, for example, when the vehicle 100 is used for adjusting supply and demand of an electric power system in a Virtual Power Plant (VPP), the first identification code of this embodiment can be used for authentication when connecting the vehicle 100 to the VPP. This makes it possible to ensure the reliability of the vehicle 100 when the vehicle 100 is connected to the VPP.

(Second embodiment) The following describes a second embodiment of the present disclosure. Hereinafter, different portions from the first embodiment will be described.

In the above first embodiment, separation and standardization of the battery data are performed by the cloud server 200, but in the second embodiment, separation of the battery data is performed by the vehicle 100, and standardization of the battery data is separately performed by the vehicle 100 and the cloud server 200.

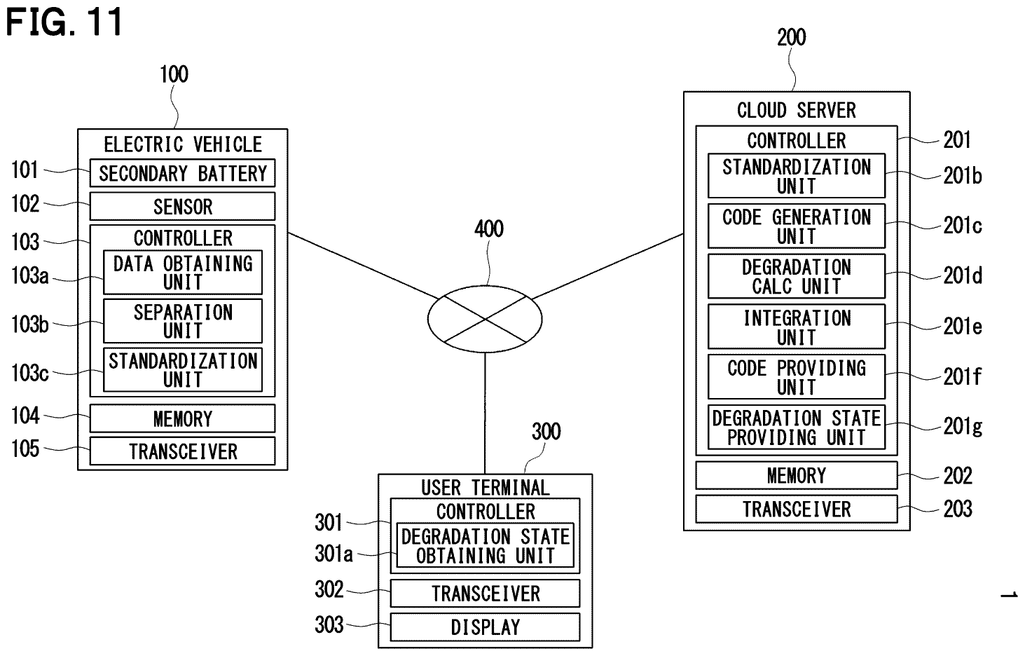

As shown in FIG. 11, in the second embodiment, the vehicle controller 103 includes a data separating unit 103b and a data standardization unit 103c. Furthermore, the cloud controller 201 does not include the data separating unit 201a, but includes a data standardization unit 201b.

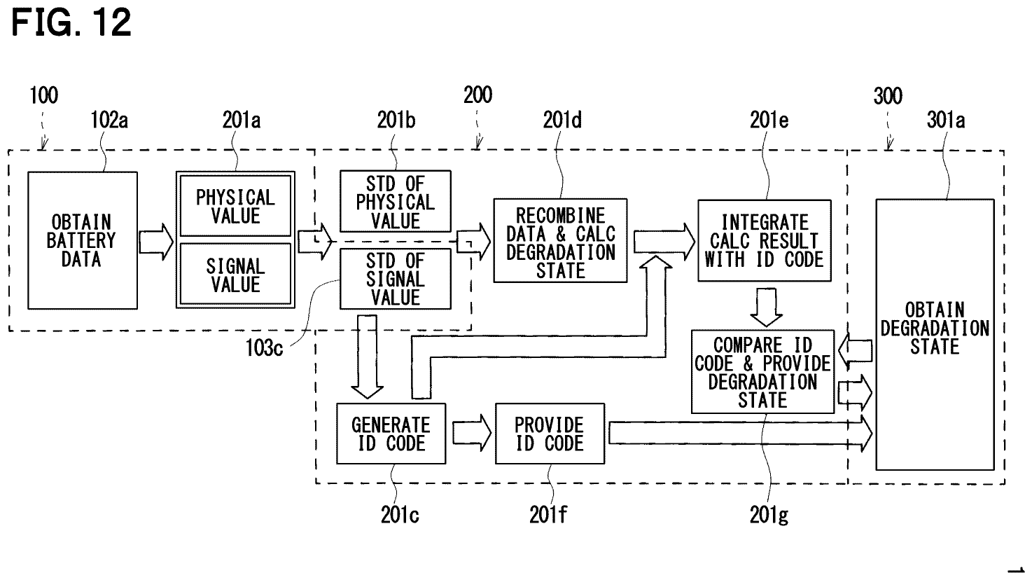

As shown in FIG. 12, in the second embodiment, the data separating unit 103b of the vehicle controller 103 performs data separation to separate the physical values and the signal values contained in the battery data. The physical values separated from the battery data are transmitted from the vehicle 100 to the cloud server 200.

In the second embodiment, the standardization of the signal values is performed by the data standardization unit 103c of the vehicle 100, and the standardization of the physical values is performed by the data standardization unit 201b of the cloud server 200. Standardization of the physical values is performed using confidential information. Thus, the cloud server 200, where security can be easily ensured, performs the standardization of the physical values. In other words, the data standardization unit 103c of the vehicle 100 serves as a signal value standardization unit that standardizes signal values, and the data standardization unit 201b of the cloud server 200 serves as a physical value standardization unit that standardizes physical values.

The signal values standardized in the vehicle 100 are transmitted from the vehicle 100 to the cloud server 200. The cloud server 200 combines the signal values standardized in the vehicle 100 with the physical values standardized in the cloud server 200. The subsequent processing is performed in the same manner as in the first embodiment.

In the second embodiment described above, the vehicle 100 separates the battery data and standardizes the signal values. As a result, a part of the processing performed by the cloud server 200 in the first embodiment can be distributed to the vehicle 100, and the processing load on the cloud server 200 can be reduced.

(Third embodiment) The following describes a third embodiment of the present disclosure. The description of the same portions as those in the above embodiments will be omitted, and differences will be described.

The data obtaining unit 103a in the third embodiment includes an impedance obtaining unit that obtains impedance data of the secondary battery 101. The impedance data is a physical quantity that changes depending on the degree of degradation of the secondary battery 101.

The data obtaining unit 103a applies different frequencies to the secondary battery 101 and obtains multiples pieces of the impedance data of the secondary battery 101 by an alternating current impedance method. The data obtaining unit 103a includes a current applier that applies alternating current at different frequencies to the secondary battery 101. The data obtaining unit 103a obtains impedance data of the secondary battery 101 at any timing within the obtaining period (for example, 24 hours) of the physical values and the signal values.

The data obtaining unit 103a obtains the current value of the alternating current applied to the secondary battery 101, and obtains the response voltage when the alternating current is applied to the secondary battery 101. The impedance is a complex impedance that is calculated, as a complex number with information on magnitude and phase, by dividing the response voltage by the alternating current that is applied to the secondary battery 101.

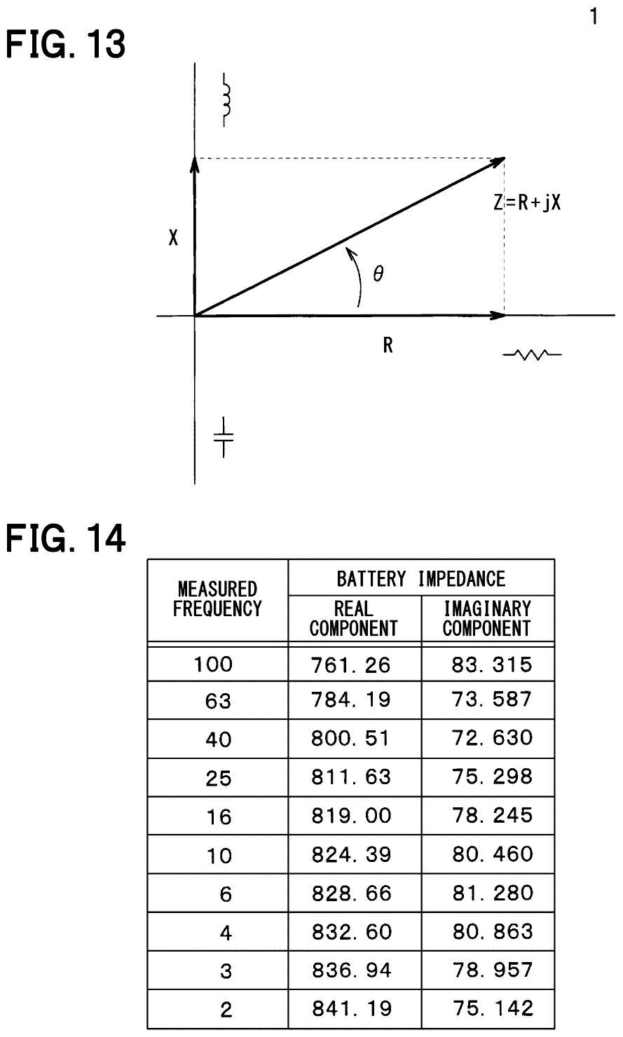

That is, as shown in FIG. 13, the complex impedance Z is expressed as “Z=R+jX”. Here, R is the real component of the complex impedance Z, and is a resistance component. X is the imaginary component of the complex impedance Z, and is the reactance component. θ is the phase between the real component and the imaginary component. For example, the data obtaining unit 103a calculates the complex impedance Z of the secondary battery 101 for each of the frequencies using a discrete Fourier transform.

FIG. 14 shows a specific example of the impedance data including the impedance of the secondary battery 101 obtained at different frequencies. The impedance data includes a combination of the real and imaginary components of the impedance obtained at different frequencies. The impedance data differs depending on the load history of the secondary battery 101, and thus the impedance data is information specific to the vehicle 100 or the secondary battery 101.

The impedance is recorded in different rules depending on vehicle models (or types of the secondary battery 101). In the example shown in FIG. 14, the definition of the LSB of the impedance is different for each vehicle model. In the example of the vehicle model A shown in FIG. 14, it is defined that the LSB of the real component is ×10⁶Ω, the LSB of the imaginary component is ×10⁶Ω and the offset of the imaginary component is 10⁻⁴Ω.

The impedance of the secondary battery 101 obtained by the data obtaining unit 103a is transmitted from the vehicle 100 to the cloud server 200, similar to the battery data, and is standardized by the data standardization unit 201b. In the standardization by the data standardization unit 201b, the impedance data recorded in different rules is re-recorded according to a unified common rule.

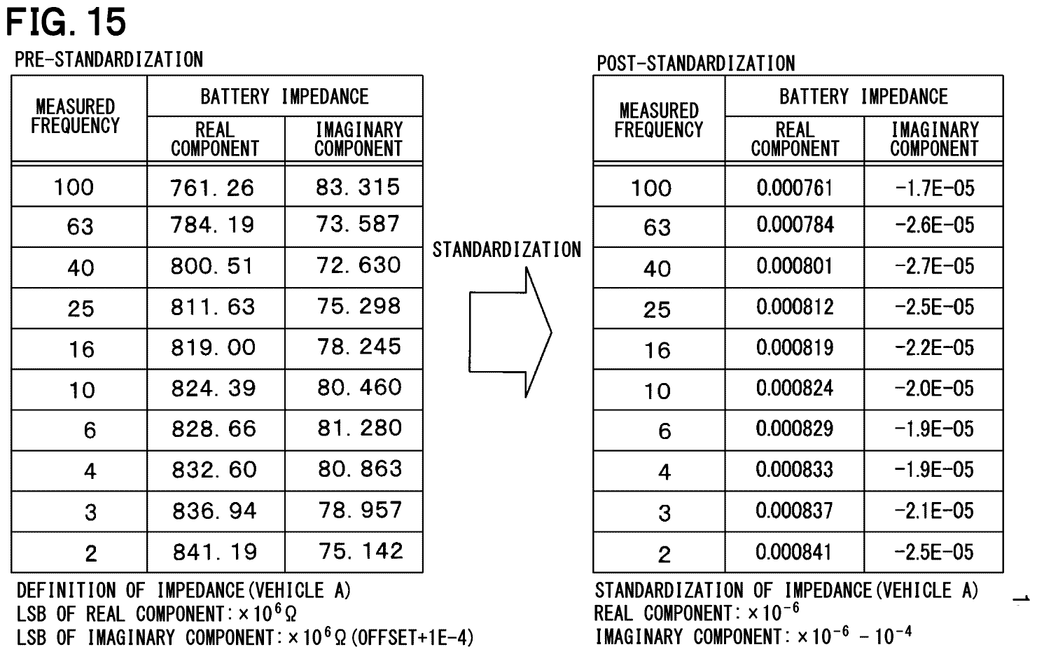

As shown in FIG. 15, when standardizing the real and imaginary components of the impedance of the vehicle type A, the value of the real component is multiplied by 10⁻⁶, the value of the imaginary component is multiplied by 10⁻⁶, and then 10⁻⁴ is subtracted. For example, the real component of 761.26 and the imaginary component of 83.315 before standardization are converted to the real component of 0.000761(Ω) and the imaginary component of −1.7E-05(Ω) by standardization.

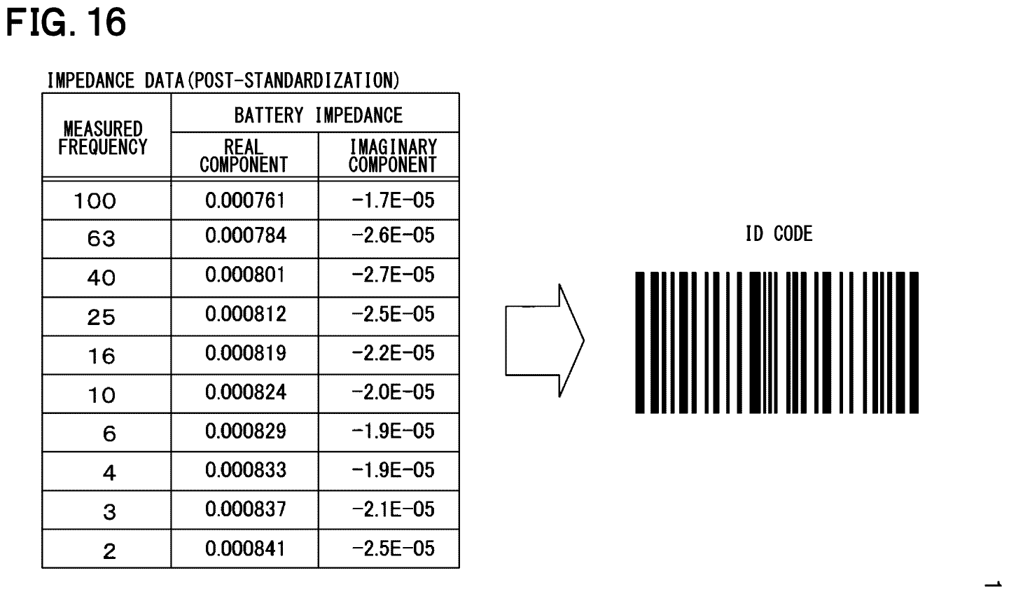

As shown in FIG. 16, the code generation unit 201c in the third embodiment generates a first identification code by using the standardized impedance of the secondary battery 101. FIG. 16 shows an example of generating the first identification code using the combination of frequency, the real component of the impedance, and the imaginary component of the impedance. The first identification code may be generated using any of a combination of frequency and the real component of impedance, a combination of frequency and the imaginary component of impedance, and a combination of the real component of impedance and the imaginary component of impedance.

The degradation state calculating unit 201d of the third embodiment may calculate the degradation state of the secondary battery 101 using standardized physical values, or may calculate the degradation state of the secondary battery 101 using standardized impedance of the secondary battery 101.

In the third embodiment described above, the impedance of the secondary battery 101 is measured at different frequencies, and the first identification code is generated using impedance data including the frequency, the real component of the impedance, and the imaginary component of the impedance. As described above, by performing individual authentication using the first identification code generated from the impedance data, reliable individual authentication can be performed, as in the case of using the first identification code generated from the signal values of the battery data in the first embodiment described above, thereby improving the reliability of the individual authentication.

The present disclosure is not limited to the above-described embodiments, and can be variously modified as follows within the scope that does not deviate from the gist of the present disclosure. Further, means disclosed in the above embodiments may be appropriately combined within a range that can be implemented.

For example, in the above embodiments, the present disclosure is applied to the vehicle 100 that operates using the secondary battery 101 as a power source, but this is not limited to this, and the present disclosure can be applied to any electrically-driven device that operates using the secondary battery 101 as a power source and has a requirement to recognize the degradation state of the secondary battery 101. For example, the electric device of the present disclosure can be used in air mobility, electric submarines, electric equipment, and the like.

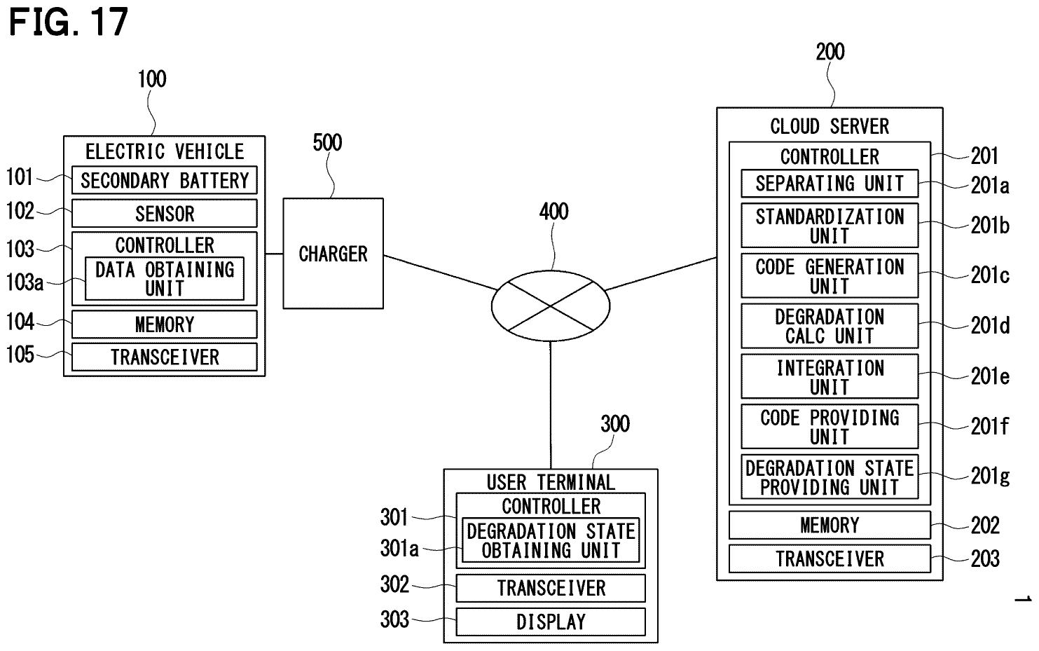

Further, in each of the above embodiments, the vehicle 100 is configured to transmit battery data directly to the cloud server 200, but the battery data may be transmitted from another vehicle 100 to the cloud server 200 via another facility. For example, as shown in FIG. 17, battery data can be transmitted from the vehicle 100 to the cloud server 200 via a charger 500. In this case, when the vehicle 100 starts charging the secondary battery 101 at the charger 500, battery data is transmitted from the vehicle 100 to the charger 500, and the battery data is further transmitted from the charger 500 to the cloud server 200.

In addition, in the above embodiments, the vehicle number of the vehicle 100 and the calculation results of the degradation state of the secondary battery 101 may be separately managed by multiple devices using blockchain technology. This makes it possible to guarantee the authenticity of the degradation state of the secondary battery 101.

In addition, in the above embodiments, the present disclosure is applied to a battery-fixed vehicle 100 in which the secondary battery 101 is fixed, but the present disclosure may also be applied to a battery-replaceable vehicle 100 in which the secondary battery 101 is replaceable.

This disclosure has been described in accordance with exemplary embodiments, but it is understood that the disclosure is not limited to those embodiments or structures. The disclosure encompasses various modifications and variations within the scope of equivalence. Additionally, while various combinations and configurations have been shown in this disclosure, other combinations and configurations that include only one element, more elements, or fewer elements are also within the scope and spirit of the disclosure.

1. A battery authentication system comprising:
a data obtaining unit configured to:
obtain time-series battery data including signal values indicative of a state of a secondary battery and physical values indicative of physical quantities of the secondary battery; and
record the signal values and the physical values based on a predetermined rule;
a data standardization unit configured to standardize the signal values and the physical values that are recorded based on different rules by re-recording the signal values and the physical values using a common rule;
a code generation unit configured to generate a first identification code to identify the secondary battery based on the standardized signal values;
a degradation state calculating unit configured to calculate a degradation state of the secondary battery based on the standardized physical values to obtain a degradation calculation result;
a degradation state integration unit configured to integrate the first identification code with the degradation calculation result to generate a second identification code containing the degradation calculation result; and
a degradation state providing unit configured to:
verify the first identification code based on the second identification code in response to a request for the degradation calculation result using the first identification code; and
output the degradation calculation result included in the second identification code based on verification of the first identification code.

2. A battery authentication system comprising:
a data obtaining unit configured to:
obtain multiple pieces of impedance data of a secondary battery measured at different frequencies; and
record the multiple pieces of impedance data based on a predetermined rule;
a data standardization unit configured to standardize the multiple pieces of impedance data that are recorded based on different rules by re-recording the multiple pieces of impedance data using a common rule;
a code generation unit configured to generate a first identification code to identify the secondary battery based on the standardized impedance data;
a degradation state calculating unit configured to calculate a degradation state of the secondary battery to obtain a degradation calculation result;
a degradation state integration unit configured to integrate the first identification code with the degradation calculation result of the secondary battery to generate a second identification code containing the degradation calculation result; and
a degradation state providing unit configured to:
verify the first identification code based on the second identification code in response to a request for the degradation calculation result using the first identification code; and
output the degradation calculation result included in the second identification code based on verification of the first identification code.

3. The battery authentication system according to claim 1, further comprising
an electric device configured to operate using the secondary battery as a power source:
a cloud server configured to receive the time-series battery data from the electric device; and
a user terminal used by a user, wherein
the electric device, the cloud server, and the user terminal are communicatively connected one another through a communication network,
the electric device includes the data obtaining unit, and
the cloud server includes the data standardization unit, the code generation unit, the degradation state calculating unit, the degradation state integration unit, and the degradation state providing unit.

4. The battery authentication system according to claim 3, further comprising
a data separating unit configured to separate the physical values and the signal values from the time-series battery data, wherein
the data standardization unit includes a physical value standardization unit configured to standardize the physical values and a signal value standardization unit configured to standardize the signal values,
the electric device includes the data separating unit and the signal value standardization unit, and
the cloud server includes the physical value standardization unit.
